(19) United States
(12) Patent Application Publication
(10) Pub. No.: US 2022/0011626 A1
(43) Pub. Date: Jan. 13, 2022

(54) TOUCH DISPLAY DEVICE

(71) Applicant: AGILE DISPLAY SOLUTIONS CO., LTD., Tainan City (TW)

(72) Inventors: Wen-Hsin WU, Tainan City (TW); Yu-Cheng HUANG, Tainan City (TW); An-Liang LIN, Tainan City (TW)

(21) Appl. No.: 17/116,497

(22) Filed: Dec. 9, 2020

(30) Foreign Application Priority Data
Jul. 7, 2020 (TW) 109122907

(51) Int. Cl. G02F 1/1335; G02F 1/1333; G06F 3/044

(52) U.S. Cl. CPC G02F 1/133502; G02F 2202/28; G06F 3/044; G02F 1/13338

(57) ABSTRACT

A touch display device includes a display module, a peripheral connector member, and a touch module. The display module includes a liquid crystal layer and an optical layered structure that is stacked on the liquid crystal layer. The peripheral connector member is disposed on a periphery of a top surface of the optical layered structure. The top surface of the optical layered structure faces away from the liquid crystal layer. The touch module is stacked on the peripheral connector member opposite to the optical layered structure so as to form a gap between the touch module and the optical layered structure. The optical layered structure has a haze ranging from 25% to 44%. The gap has a height that is measured from the touch module to the optical layered structure, and that ranges from 0.01 to 3 mm.

### CROSS-REFERENCE TO RELATED APPLICATION

This application claims priority of Taiwanese Invention Patent Application No. 109122907, filed on Jul. 7, 2020.

### FIELD

The present disclosure relates to a display device, and more particularly to a touch display device.

### BACKGROUND

A conventional touch display device generally includes an assembly of a display module and a touch module that is stacked on the display module. The touch module includes a protective glass layer that is disposed on and spaced apart from the display module. However, an air gap is formed between the two modules, which causes light emitted from the display module to be refracted twice due to the difference in the refractive indexes of the display module, the air gap, and the protective glass layer (i.e., a first refraction occurs when the light enters the air gap from the display module, and a second refraction occurs when the light enters the protective glass layer of the touch module from the air gap). The larger the air gap is, the greater the impact of light refraction on an image is. Namely, such impact might result in a parallax phenomenon and adversely affect touch accuracy, and might simultaneously reduce image clarity of the touch display device.

On the other hand, the existence of air gap would cause light radiated from an ambient light source onto the touch display device to bring about phenomena of glare and/or Newton's rings due to optical interference. Therefore, a user might easily feel discomfort in the eyes, and also the image quality might be adversely affected.

A conventional approach to overcome the aforementioned problems is to dispose an optical bonding layer between the touch module and the display module so as to fill the air gap therebetween. Such approach can greatly reduce the parallax phenomenon caused by reflection and refraction of light, and can also achieve the effect of reducing optical interference. However, this conventional approach incurs a relatively high manufacturing cost due to the need of adding the optical bonding layer.

Alternatively, an optical structure may be disposed on a side of the protective glass layer that faces the display module, so as to reduce Newton's rings phenomenon. However, such approach might easily cause light radiated from an ambient light source onto the touch display to be strongly reflected, and might also result in the optical structure's scratching on the display module (that is positioned below the optical structure) during operation of the touch module.

### SUMMARY

Therefore, an object of the present disclosure is to provide a touch display device that can alleviate at least one of the drawbacks of the prior art.

According to the present disclosure, the touch display device includes a display module, a peripheral connector member, and a touch module. The display module includes a liquid crystal layer and an optical layered structure that is stacked on the liquid crystal layer. The peripheral connector member is disposed on a periphery of a top surface of the optical layered structure. The top surface of the optical layered structure faces away from the liquid crystal layer. The touch module is stacked on the peripheral connector member opposite to the optical layered structure so as to form a gap between the touch module and the optical layered structure. The optical layered structure has a haze ranging from 25% to 44%. The gap has a height that is measured from the touch module to the optical layered structure, and that ranges from 0.01 to 3 mm.

### BRIEF DESCRIPTION OF THE DRAWINGS

Other features and advantages of the present disclosure will become apparent in the following detailed description of the embodiments with reference to the accompanying drawings, of which:

FIG. 1 is a fragmentary cross-sectional view illustrating an embodiment of a touch display device according to the present disclosure;

FIG. 2 is a fragmentary schematic view illustrating a touch module and an optical layered structure of the embodiment, in which light refraction generates a parallax distance; and

FIG. 3 is a graph illustrating the parallax distance measured under different viewing angles and different heights of a gap of the embodiment.

### DETAILED DESCRIPTION

Before the present disclosure is described in greater detail, it should be noted that where considered appropriate, reference numerals or terminal portions of reference numerals have been repeated among the figures to indicate corresponding or analogous elements, which may optionally have similar characteristics.

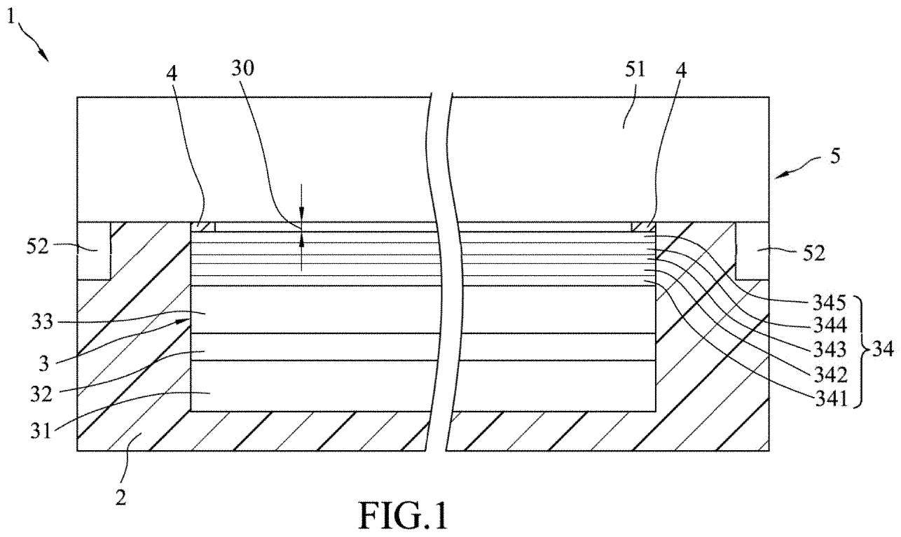

Referring to FIG. 1, an embodiment of a touch display device 1 according to the present disclosure includes a housing 2 having an upward opening, a display module 3, a peripheral connector member 4, and a touch module J.

The display module 3 includes a backlight unit 31, a lower polarizing plate 32, a liquid crystal layer 33, and an optical layered structure 34 which are disposed in the housing 2 in such order from a bottom of the housing 2 toward the upward opening of the housing 2. To be specific, the backlight unit 31 is disposed below the liquid crystal layer 33 opposite to the optical layered structure 34, the lower polarizing plate 32 is disposed between the liquid crystal layer 33 and the backlight unit 31, and the optical layered structure 34 is stacked on the liquid crystal layer 33. Since the backlight unit 31, the lower polarizing plate 32 and the liquid crystal layer 33 are well known to those skilled in the art and are not the focus of the present disclosure, further details thereof are not provided herein for the sake of brevity.

The optical layered structure 34 includes a pressure-sensitive adhesive layer 341, an optical compensation layer 342, a polarizing layer 343, a protective layer 344, and a surface treatment layer 345 which are stacked on the liquid crystal layer 33 in such order.

The pressure-sensitive adhesive layer 341 functions as an adhesive that can be adhered to a surface of an object by applying a little pressure. Examples of a material for making the pressure-sensitive adhesive layer 341 may include, but are not limited to, natural rubber, styrene-butadiene rubber, and an acrylic resin. The optical compensation layer 342 can correct phase difference of light at different viewing angles caused by liquid crystal molecules in the liquid crystal layer 33. The polarizing layer 343 is used to filter light emitted from the liquid crystal layer 33 so as to allow light having a particular polarization direction to pass through. The protective layer 344 is disposed on the polarizing layer 343 to prevent water vapor or oxygen gas from penetrating into the polarizing layer 343, thereby avoiding adverse influence on the function of the polarizing layer 343. The surface treatment layer 345 is, for example, an anti-glare coating layer or an anti-reflection coating layer, but is not limited thereto. The surface treatment layer 345, which has been subjected to a special surface treatment, has a predetermined haze.

In this embodiment, the peripheral connector member 4 is disposed on a periphery of a top surface of the surface treatment layer 345 of the optical layered structure 34. The top surface of the surface treatment layer 345 of the optical layered structure 34 faces away from the liquid crystal layer 33.

The touch module 5 is stacked on and abuts against the peripheral connector member 4 opposite to the optical layered structure 34, so that a gap 30 is formed between the touch module 5 and the display module 3. In this embodiment, the touch module 5 is an optical touch sensor module, and includes a protective glass 51 that abuts against the peripheral connector member 4 and that cooperates with the surface treatment layer 345 of the optical layered structure 34 of the display module 3 to form the gap 30 having a height measured from the protective glass 51 to the surface treatment layer 345, and a touch sensing unit 52 that is disposed on a periphery of a bottom surface of the protective glass 51 without contacting the peripheral connector member 4. The bottom surface of the protective glass 51 faces toward the housing 2.

In other embodiments, the touch module 5 may be a capacitive touch module or a resistive touch module. In such case, the touch sensing unit 52 is a layered film structure that is stacked on the bottom surface of the protective glass 51 and that abuts against the peripheral connector member 4, so as to form the gap 30 having a height measured from the touch sensing unit 52 to the surface treatment layer 345 of the optical layered structure 34. Since various types of the touch module 5 are well known to those skilled in the art and are not the focus of the present disclosure, further details thereof are not provided herein for the sake of brevity.

In order to find out the suitable range of the predetermined haze of the surface treatment layer 345, four touch display devices 1 (i.e., test samples A to D), which respectively include the optical layered structures 34 with the surface treatment layers 345 having different hazes, were subjected to observation of Newton's rings phenomenon. The hazes applied and the results obtained are summarized in Table 1 below.

TABLE 1

| Test sample | A | B | C | D |
|---|---|---|---|---|
| Haze (%) | <1 | 25 | 28 | 44 |
| Newton's | Visible | Invisible | Invisible | Invisible |
| rings | | | | |
| phenomenon | | | | |

As demonstrated in Table 1, when the surface treatment layer 345 is adjusted so that the haze of the optical layered structure 34 is equal to or greater than 25%, Newton's rings phenomenon can be effectively eliminated. On the other hand, when the haze of the optical layered structure 34 is greater than 44%, the clarity of the image produced by the touch display device 1 will be too low. Therefore, when the haze of the optical layered structure 34 is adjusted to range from 25% to 44%, the quality of the image produced by the touch display device 1 will not be adversely affected and Newton's rings phenomenon can be effectively eliminated.

The reflection ratio is defined as a ratio of an intensity of light reflected from the protective glass 51 to an intensity of light reflected from the optical layered structure 34 (both types of reflected light arise from incident light entering the touch display device 1 from the protective glass 51). The smaller the reflection ratio, the less likely ambient light is to be reflected in the gap 30 of the touch display device 1, and thus, the less likely the glare problem resulting from optical interference is to occur.

The height of the gap 30 of the four touch display devices 1 (i.e., the abovementioned test samples A to D), which respectively include the optical layered structures 34 having the haze values shown in Table 1, was adjusted, so as to measure the corresponding intensity of reflected light. Specifically, a laser displacement sensor, which was spaced apart from a surface of the touch display device 1 by a vertical distance of 46.3 mm, served as a light source having a wavelength of 650 nm to emit incident light which enters the touch display device 1 at an incident angle of 15°, and also served as a receiver to receive light reflected by the touch display device 1, so as to determine the intensity of such reflected light.

During measurement of light reflection intensity, the laser displacement sensor could receive both the light reflected from the protective glass 51 and the light reflected from the optical layered structure 34, and could distinguish these two types of reflected light based on the distances of reflected light traveling from the protective glass 51 and the optical layered structure 34 to the laser displacement sensor. Therefore, the intensities of the two types of reflected light and the reflection ratio could be determined.

The results are summarized in Table 2 below.

TABLE 2

| | |
|---|---|
| Height of | Reflection ratio of test sample |

| gap (mm) | A | B | C | D |
|---|---|---|---|---|
| 0.5 | 1.31 | 0.33 | 0.27 | 0.08 |
| 1.8 | 1.31 | 0.35 | 0.33 | 0.17 |
| 2.3 | 1.31 | 0.36 | 0.41 | 0.17 |
| 3.5 | 1.31 | 0.49 | 0.47 | 0.33 |
| 5.0 | 1.31 | 0.49 | 0.51 | 0.41 |

As shown in Table 2, when the height of the gap 30 was fixed, test samples B to D having a haze that ranges from 25% to 44% as shown in Table 1 showed a smaller reflection ratio compared to that of test sample A. Furthermore, when the height of the gap 30 became smaller, each of test samples B to D showed a reduced reflection ratio.

Since the gap 30 is formed by stacking the touch module 5 on the peripheral connector membrane 4 opposite to the optical layered structure 34, the height of the gap 30 is at least approximately 0.01 mm due to the required minimum thickness of the peripheral connector member 4. Therefore, when the haze of the optical layered structure 34 ranges from 25% to 44% and the height of the gap 30 measured from the touch module 5 to the optical layered structure 34 ranges from 0.01 mm to 5.0 mm, Newton's rings can be effectively eliminated and the incidence of the glare phenomena can be effectively reduced.

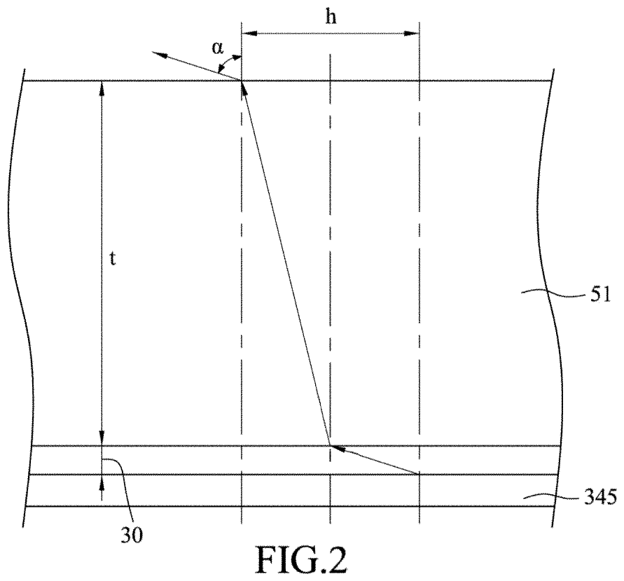

FIG. 2 illustrates that the protective glass 51 has a thickness (t) which is approximately equal to 3 mm, and that a user's viewing angle (a) on the protective glass 51 generally ranges from 5° to 30°. Since a heterogeneous interface is formed between the protective glass 51 and the air thereabove, and since another heterogeneous interface is formed between and the protective glass 51 and the gap 30, light will be refracted twice when passing through these two heterogeneous interfaces, generating a parallax distance (h) which is measured from an imaginary extension line passing through a light entrance point at the bottom of the gap 30 to another imaginary extension line passing through a light exit point at the top surface of the protective glass 51.

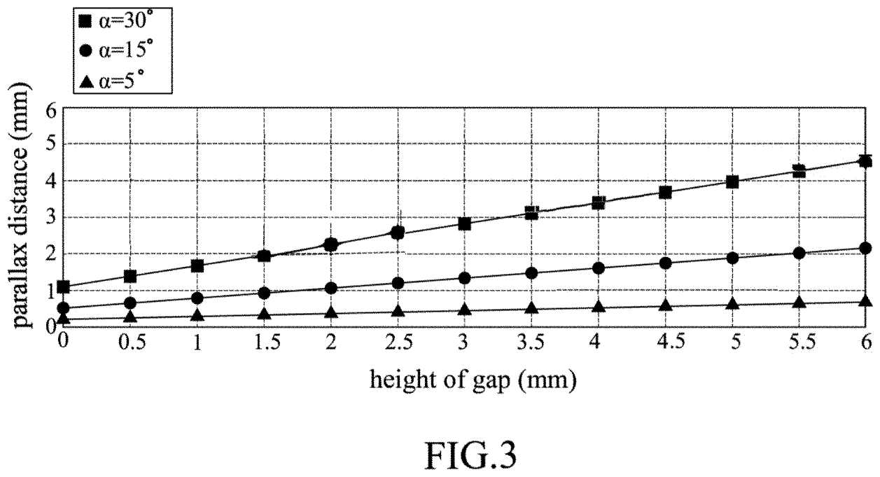

Referring to FIG. 3, when the user's viewing angles (a) are respectively equal to 5°, 15°, and 30°, the parallax distance (h) arising from different heights of the gap 30 can be calculated using Snell's Law and a trigonometric function. To ensure the touch accuracy, the parallax distance (h) is required to be not greater than a diameter of a tip of a stylus. Since the diameter of a tip of a stylus is usually about 3 mm, the parallax distance (h) is required to be not greater than 3 mm. The result in Table 3 shows that when the height of the gap 30 is less than or equal to 3 mm, the calculated parallax distance (h) is not greater than 3 mm. Therefore, when the height of the gap 30 is adjusted to be not greater than 3 mm, parallax phenomenon can be effectively eliminated so as to improve touch accuracy.

In summary, by virtue of the optical layered structure 34 having a haze that ranges from 25% to 44%, and the gap 30 having a height that is measured from the touch module 5 to the optical layered structure 34 and that ranges from 0.01 mm to 3 mm, problems such as Newton's rings, glare and parallax phenomena can be simultaneously solved, such that the touch display device 1 of the present disclosure has improved touch accuracy and image quality.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the present disclosure has been described in connection with what is considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A touch display device, comprising:
a display module including a liquid crystal layer and an optical layered structure that is stacked on said liquid crystal layer;
a peripheral connector member disposed on a periphery of a top surface of said optical layered structure, said top surface of said optical layered structure facing away from said liquid crystal layer; and
a touch module stacked on said peripheral connector member opposite to said optical layered structure so as to form a gap between said touch module and said optical layered structure,
wherein said optical layered structure has a haze ranging from 25% to 44%, and
wherein said gap has a height that is measured from said touch module to said optical layered structure, and that ranges from 0.01 mm to 3 mm.

2. The touch display device as claimed in claim 1, wherein said optical layered structure includes a pressure-sensitive adhesive layer, an optical compensation layer, a polarizing layer, a protective layer, and a surface treatment layer which are stacked on said liquid crystal layer in such order.

3. The touch display device as claimed in claim 2, wherein said surface treatment layer is one of an anti-glare coating layer and an anti-reflection coating layer.

4. The touch display device as claimed in claim 3, wherein said display module further includes a backlight unit that is disposed below said liquid crystal layer opposite to said optical layered structure.

5. The touch display device as claimed in claim 4, wherein said display module further includes a lower polarizing plate that is disposed between said liquid crystal layer and said backlight unit.
